(19) United States
(12) Patent Application Publication
(10) Pub. No.: US 2013/0195012 A1
(43) Pub. Date: Aug. 1, 2013

(54) NETWORK ATTACH PROCEDURE FOR LONG TERM EVOLUTION LOCAL AREA NETWORK

(71) Applicant: NOKIA SIEMENS NETWORKS OY, Espoo (FI)

(72) Inventors: Matti Einari LAITILA, Oulu (FI); Seppo Illmari VESTERINEN, Oulunsalo (FI)

(73) Assignee: NOKIA SIEMENS NETWORKS OY, Espoo (FI)

(21) Appl. No.: 13/737,420

(22) Filed: Jan. 9, 2013

Related U.S. Application Data
(60) Provisional application No. 61/592,288, filed on Jan. 30, 2012.

(51) Int. Cl. H04W 76/00

(52) U.S. Cl. CPC H04W 76/00
USPC 370/328

(57) ABSTRACT

One embodiment is directed to a method and apparatus for performing a network entry procedure for dual radio (LTE+LTE-Hi) capable user equipment to access a LTE-LAN and its services. The method includes detecting a LTE-LAN network from broadcasted system information, and requesting LTE-Hi services. The method may further include transmitting a connection setup handshake to the LTE-LAN AP. The connection setup handshake may include a LTE-LAN UE ID. The method may further include, after the connection establishment to the LTE-LAN AP, sending a LAN attach request message to a SeNB with the LTE-LAN UE ID or sending an announcement to the SeNB through ordinary macro radio connections to indicate the LTE-LAN UE ID in the LTE-LAN AP.

### CROSS REFERENCE TO RELATED APPLICATIONS

This application claims the benefit of U.S. provisional application No. 61/592,288, filed on Jan. 30, 2012. The entire contents of this earlier filed application are incorporated herein.

### BACKGROUND

1. Field

Embodiments of the invention relate to wireless communications networks, such as the Universal Mobile Telecommunications System (UMTS) Terrestrial Radio Access Network (UTRAN) Long Term Evolution (LTE) and Evolved UTRAN (E-UTRAN).

2. Description of the Related Art

Universal Mobile Telecommunications System (UMTS) Terrestrial Radio Access Network (UTRAN) refers to a communications network including base stations, or Node-Bs, and radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS).

Long Term Evolution (LTE) refers to improvements of the UMTS through improved efficiency and services, lower costs, and use of new spectrum opportunities. In particular, LTE is a 3rd Generation Partnership Project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE improves spectral efficiency in communication networks, allowing carriers to provide more data and voice services over a given bandwidth. Therefore, LTE is designed to fulfill future needs for high-speed data and media transport in addition to high-capacity voice support. Advantages of LTE include high throughput, low latency, FDD and TDD support in the same platform, an improved end-user experience, and a simple architecture resulting in low operating costs. In addition, LTE is an all internet protocol (IP) based network, supporting both IPv4 and IPv6.

The Evolved 3GPP Packet Switched Domain, which is also known as the Evolved Packet System (EPS), provides IP connectivity using the E-UTRAN.

### SUMMARY

One embodiment is directed to a method for performing a network entry procedure to access a LTE-LAN. The method includes detecting a LTE-LAN network from broadcasted system information, and requesting LTE-Hi services. The method may further include transmitting a connection setup handshake to the LTE-LAN AP. The connection setup handshake may include a LTE-LAN UE ID. The method may further include, after the connection establishment to the LTE-LAN AP, sending a LAN attach request message to a SeNB with the LTE-LAN UE ID or sending an announcement to the SeNB through ordinary macro radio connections to indicate the LTE-LAN UE ID in the LTE-LAN AP. The SeNB may then bind the LTE-LAN user context in the access point together with the SeNB user context for the same user equipment.

Another embodiment is directed to a method for performing a network entry procedure to access a LTE-LAN. The method includes receiving, from a UE or LTE-LAN AP, an attach request message that may include the LTE-LAN UE ID and information regarding the LAN radio network cell and the LTE-LAN AP. The method may further include performing the authentication/authorization for the UE's LTE-LAN entry, and sending an initial context setup/attach response message with the received LTE-LAN UE ID as a UE identifier in order to start the context transfer procedure. The method may also include deciding which bearers are moved to LTE-LAN access based on preconfigured policies.

Another embodiment is directed to an apparatus including at least one processor and at least one memory including computer program code. The at least one memory and the computer program code is configured, with the at least one processor to cause the apparatus at least to detect a LTE-LAN network from broadcasted system information, and request LTE-Hi services. The at least one memory and the computer program code may be further configured, with the at least one processor to cause the apparatus at least to transmit a connection setup handshake, which may include a LTE-LAN UE ID, to the LTE-LAN AP, and, after the connection establishment to the LTE-LAN AP, to send a LAN attach request message to a SeNB with the LTE-LAN UE ID or send an announcement to the SeNB through ordinary macro radio connections to indicate the LTE-LAN UE ID in the LTE-LAN AP.

Another embodiment is directed to an apparatus including at least one processor and at least one memory including computer program code. The at least one memory and the computer program code is configured, with the at least one processor to cause the apparatus at least to receive, from a UE or LTE-LAN AP, an attach request message that may include the LTE-LAN UE ID and information regarding the LAN radio network cell and the LTE-LAN AP. The at least one memory and the computer program code may be further configured, with the at least one processor to cause the apparatus at least to perform the authentication/authorization for the UE's LTE-LAN entry, and to send an initial context setup/attach response message with the received LTE-LAN UE ID as a UE identifier in order to start the context transfer procedure. The at least one memory and the computer program code may also be further configured, with the at least one processor to cause the apparatus at least to decide which bearers are moved to LTE-LAN access based on preconfigured policies.

Another embodiment is directed to a computer program embodied on a non-transitory computer readable medium. The computer program is configured to control a processor to perform a process including detecting a LTE-LAN network from broadcasted system information, and requesting LTE-Hi services. The process may further include transmitting a connection setup handshake to the LTE-LAN AP. The connection setup handshake may include a LTE-LAN UE ID. The process may further include, after the connection establishment to the LTE-LAN AP, sending a LAN attach request message to a SeNB with the LTE-LAN UE ID or sending an announcement to the SeNB through ordinary macro radio connections to indicate the LTE-LAN UE ID in the LTE-LAN AP.

Another embodiment is directed to a computer program embodied on a non-transitory computer readable medium. The computer program is configured to control a processor to perform a process including receiving, from a UE or LTE-LAN AP, an attach request message that may include the LTE-LAN UE ID and information regarding the LAN radio network cell and the LTE-LAN AP. The process may further include performing the authentication/authorization for the UE's LTE-LAN entry, and sending an initial context setup/attach response message with the received LTE-LAN UE ID as a UE identifier in order to start the context transfer procedure. The process may also include deciding which bearers are moved to LTE-LAN access based on preconfigured policies.

Another embodiment is directed to an apparatus. The apparatus includes detecting means for detecting a LTE-LAN network from broadcasted system information, and requesting means for requesting LTE-Hi services. The apparatus may further include transmitting means for transmitting a connection setup handshake to the LTE-LAN AP. The connection setup handshake may include a LTE-LAN UE ID. The apparatus may further include, after the connection establishment to the LTE-LAN AP, sending means for sending a LAN attach request message to a SeNB with the LTE-LAN UE ID or sending an announcement to the SeNB through ordinary macro radio connections to indicate the LTE-LAN UE ID in the LTE-LAN AP. The SeNB may then bind the LTE-LAN user context in the access point together with the SeNB user context for the same user equipment.

Another embodiment is directed to an apparatus. The apparatus includes receiving means for receiving, from a UE or LTE-LAN AP, an attach request message that may include the LTE-LAN UE ID and information regarding the LAN radio network cell and the LTE-LAN AP. The apparatus may further include performing means for performing the authentication/authorization for the UE's LTE-LAN entry, and sending means for sending an initial context setup/attach response message with the received LTE-LAN UE ID as a UE identifier in order to start the context transfer procedure. The apparatus may also include deciding means for deciding which bearers are moved to LTE-LAN access based on preconfigured policies.

### BRIEF DESCRIPTION OF THE DRAWINGS

For proper understanding of the invention, reference should be made to the accompanying drawings, wherein:

FIG. 1 illustrates a system according to one embodiment of the invention;

FIG. 2 illustrates a system according to another embodiment;

FIG. 3 illustrates an apparatus according to one embodiment;

FIG. 4 illustrates a flow diagram of a method according to one embodiment;

FIG. 5 illustrates a flow diagram of a method according to another embodiment;

FIG. 6 illustrates an apparatus according to another embodiment; and

FIG. 7 illustrates an apparatus according to another embodiment.

### DETAILED DESCRIPTION

The LTE core network may include a Mobility Management Entity (MME), Packet Data Network Gateway (PGW), and Serving Gateway (SGW). The MME may be connected to the SGW via an S1 interface, and the SGW in turn may be connected to the PGW via an S5 interface, for example.

The MME may be considered the main control node for the core network. Some features handled by the MME include: bearer activation/de-activation, idle mode UE tracking, choice of SGW for a UE, intra-LTE handover involving core network node location, interacting with the home location register (HLR)/home subscriber server (HSS) to authenticate user on attachment, and providing temporary identities for UEs.

The HLR/HSS is a central database that contains user-related and subscription-related information. Functions of the HLR/HSS may include mobility management, call and session establishment support, user authentication and access authorization.

The SGW is a data plane element within the core network. The SGW manages user plane mobility and acts as the main interface between the radio access network(s) and the core network. The SGW can also maintain the data path between the eNBs and the PGW. As a result, the SGW may form an interface for the data packet network at the E-UTRAN. The SGW may also be in communication with home public land mobile network (HPLMN) gateway which may store the home user's subscription data. The PGW provides connectivity for the UE to external packet data networks (PDNs). A UE may have connectivity with more than one PGW for accessing multiple PDNs.

A serving GPRS support node (SGSN) may be provided in the core network to transfer information to and from the GERAN and UTRAN via an Iu interface, for example. The SGSN may communicate with the SGW via the S4 interface. The SGSN may store location information for a UE, such as current cell, and may also store user profiles, such as international mobile subscriber identity (IMSI).

Along with the development of the LTE system, high-speed data service has been considered one of the most important requirements. Especially for local area networks, a higher data rate is expected from a user's point of view. As a result, ways to provide local service with high speed data rates has become a hot topic in 3GPP.

The local area evolution (LAE) project aims to design a local area system providing high performance on peak data rate, cell capacity, QoS guarantee, interference management, etc. In addition, low cost and high energy efficiency are also expected for the LAE system. In the LAE system, a support node (SN) concept is introduced. The SN is a network element located in the core network, providing some support/control/maintenance functionalities to the LAE system. The BS is located in the RAN side which provides the local area network, similar to the HeNB in the LTE system. The UE can maintain two connections with the macro eNB and the LAE BS. These two connections are referred to as “dual radio connections.” The macro network connection may be more stable and more carefully managed so that the UE does not easily lose its connection, while the LAE connection may be used more for providing high speed data service in the local area.

The Long Term Evolution—Local Area Network (LTE-LAN) is a local network intended to compete with the popular wireless data exchange technique provided by WiFi, for example. LTE-LAN may be based on LTE technology, but is more focused on some local area use cases and scenarios. LTE-LAN has certain similarities with the LAE concept discussed above. LTE-LAN is expected to provide high performance service for users with low cost, and is expected to become a competitor to WiFi.

Embodiments of the invention are directed to an architecture, based on the LTE-LAN and LAE concept, known as the LTE-Hi concept. Some basic assumptions of the LTE-Hi concept include: dual band operation; local and wide area accesses are using different radios; and autonomous (local area) operation to the mobile core network, e.g., the usage of the LTE-LAN network is transparent to core network for simplicity and lightening the signaling load.

The transparent operation to the core network means that LTE-Hi access control functions, such as authentication, authorization and bearer management, which are normally performed by the MME, should be handled at the E-UTRAN and LTE-LAN level. As a result, a new network entry procedure for accessing the LTE-LAN network and its services is required.

According to the current 3GPP LTE-SAE specification (TS 23.401), a UE with a subscriber identity module (SIM) card is identified and authorized by the mobile core network using the IMSI as a user ID. The IMSI, however, is not visible in the E-UTRAN and is not stored in the RAN network elements for security reasons. Temporary user identifiers are utilized instead of the IMSI. Also, the UE may have LTE-LAN specific identifiers that are separate from the identifiers used in the mobile network. Thus, another way to identify and authenticate a UE with dual radio capability in the LTE-Hi concept is needed.

Embodiments of the invention provide a new network entry procedure for dual radio (LTE+LTE-Hi) capable UEs to access a LTE-LAN network and its services. In one embodiment, the network entry procedure can be executed autonomously at the E-UTRAN level, based on the new network architecture composed of a LTE-LAN subsystem (LTE-Hi access points) overlaying macro base stations, and the LTE-LAN control entity located in the macro eNB(s). This network entry procedure may be executed fully transparently to the EPC or with minimal changes in the current EPS if desired.

Some basic assumptions in the proposed local area architecture for a LTE-Hi concept include the following:
Dual radio operation. One radio for wide area operation and another one for local area operation.
Local area base stations called LTE-LAN Access Points (LAN APs or LTE-Hi APs) might not have direct connection/interface to the mobile core network.
LAN APs would have direct S1-like (simplified) interface towards their neighbor/overlaying macro eNB.
The usage of the LTE-LAN radio and local LTE-Hi services can be kept transparent to the mobile core network (EPC) if desired.
Macro eNB hosts the required functions for supporting LTE-Hi access and dual radio services control.
LTE-LAN network may host the required functions, e.g., a local authentication server to support LTE-Hi services for the LTE-Hi radio capable UEs without a SIM.
LTE-LAN network may provide direct UE access to services located in the LTE-LAN network or to an external network, e.g., the Internet, without user traffic traversing via the serving macro eNB or mobile core network.

Some basic assumptions for a dual radio capable UE (LTE and LTE-Hi radios) include the following:
UE has a subscription (i.e., a SIM card) to a mobile network (e.g., PLMN) supporting LTE and LTE-Hi services.
UE has a subscription and identifiers to access LTE-Hi services. These may be separated from the mobile network subscription in order to enable SIM-less UE access to LTE-Hi services.

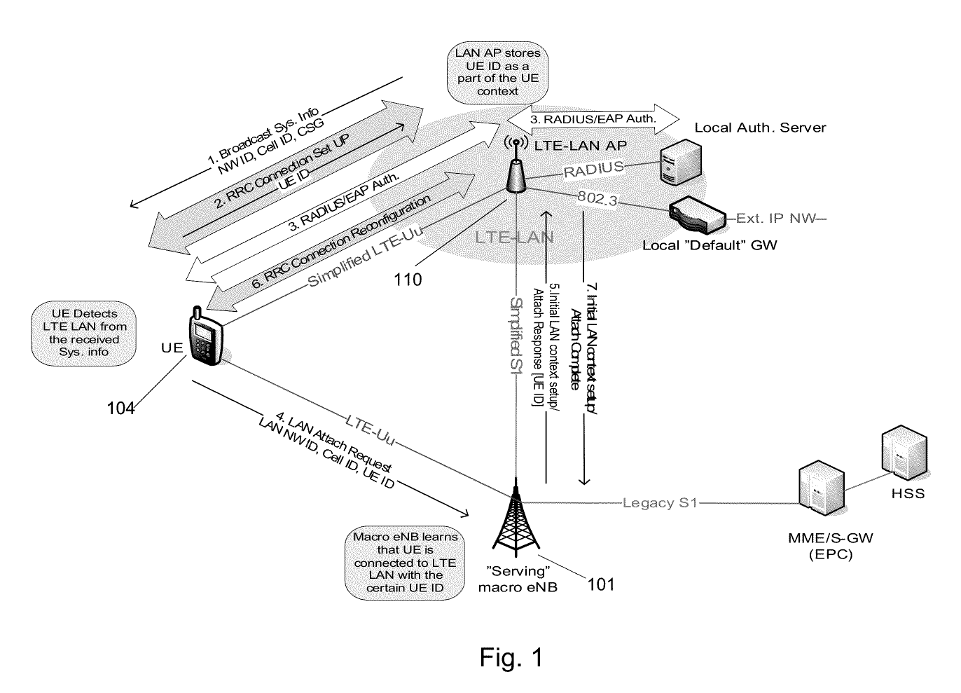

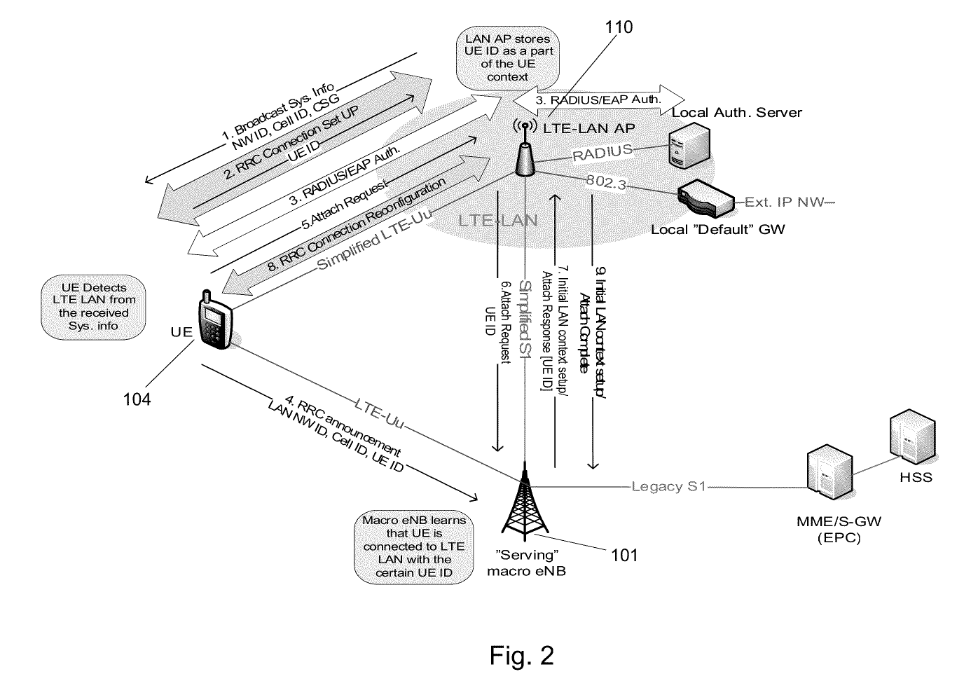

FIGS. 1 and 2 discussed below illustrate the signaling flow for the LTE-Hi network entry procedure for a UE to access the LTE-LAN network and its services, according to certain embodiments. In an embodiment, the UE has dual radio capability and a SIM card.

FIG. 1 illustrates an example of a network entry procedure to the LTE-LAN subsystem, according to an embodiment. In one embodiment, the network entry procedure to the LTE-LAN subsystem is performed with a LAN attach request message through a macro connection.

According to certain embodiments, at 1, UE 104 connected to serving macro eNB 101 detects a LTE-LAN network from the broadcasted system Information and decides to request LTE-Hi services. The UE 104 may include a LTE-LAN UE ID, at 2, in a radio resource control (RRC) connection setup handshake to the LTE-LAN AP 110. The LTE-LAN AP 110 stores the LTE-LAN UE ID as a part of the UE context. In some embodiments, the UE ID may be: a LTE-LAN specific SAE temporary mobile subscriber identity (S-TMSI); a unique device hardware ID such as international mobile equipment identity (MEI) or medium access control (MAC) address of the LAN radio interface; a universal integrated circuit card (UICC) (SIM) card related ID such as an integrated circuit card identifier (ICCID), which bounds access to the subscription, instead of the device; Network Access Identifier (NAI), which is a user specific identifier; or some other random identifier.

Returning to FIG. 1, optional authentication to a local authentication server 111 could be performed after RRC connection setup. As illustrated in FIG. 1, in an embodiment, LTE-LAN AP 110 may host RADIUS client functionality towards a local radius server. After RRC connection establishment to LTE-LAN AP 110 and optional authentication to local authentication server 111, at 4, UE 104 sends a LAN attach request RRC message to the serving macro eNB (SeNB) 101 with the UE LAN ID and information of the LAN radio network cell and AP. The SeNB 101 learns from the LAN attach request message that UE 104 is connected to a certain LAN AP/cell with the certain LTE-LAN UE ID. The SeNB 101 may then perform the authentication/authorization for the UE's LTE-LAN entry and start the context transfer procedure by sending, at 5, the initial LAN context setup/attach response message, with received LTE-LAN UE ID as an UE Identifier. The SeNB 101 may decide, based on the preconfigured policies, which bearers are moved to LTE-LAN access.

FIG. 2 illustrates an example of a network entry procedure to the LTE-LAN subsystem, according to another embodiment. In an embodiment, the network entry procedure to the LTE-LAN subsystem is performed with a LAN attach request message through a LTE-LAN connection.

FIG. 2 is similar to the network entry procedure illustrated in FIG. 1, with the exception that the UE 104 sends an announcement 4 to the SeNB 101 through ordinary macro radio connections to indicate that it has LTE-LAN UE ID in the LTE-LAN AP. The Attach request message 5 is sent through LTE-LAN radio to the LTE-LAN AP 110. UE 104 informs the LTE-LAN AP 110 about the SeNB 101 it is connected to in the RRC connection setup handshake 2 or in the attach request message 5. The LTE-LAN AP 110 forwards the attach request message 6 with the LTE-LAN UE ID to the correct SeNB 101 based on the received information from the UE 104. The SeNB 101 performs the authentication/authorization for the LTE-LAN UE ID.

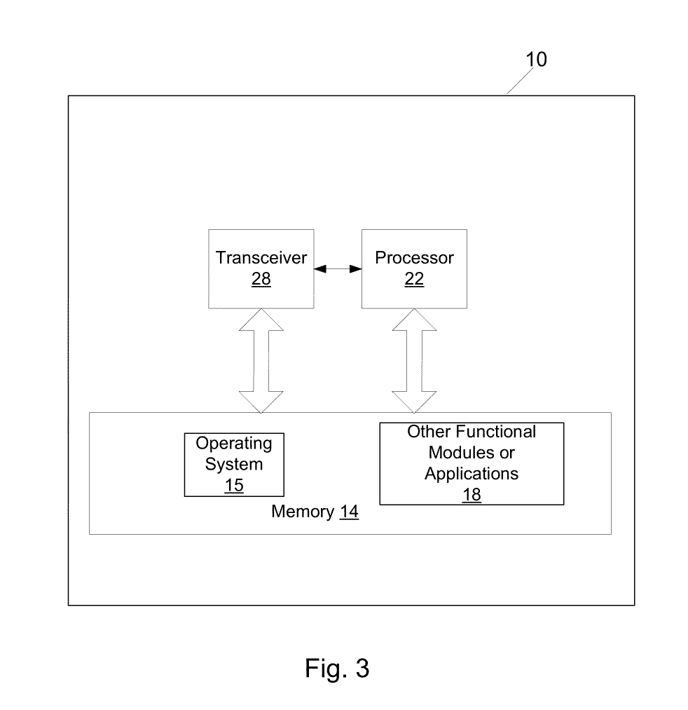

FIG. 3 illustrates an apparatus 10 according to one embodiment. In an embodiment, apparatus 10 may be the UE 104 or the SeNB 101 illustrated in FIGS. 1 and 2. Apparatus 10 includes a processor 22 for processing information and executing instructions or operations. Processor 22 may be any type of general or specific purpose processor. While a single processor 22 is shown in FIG. 3, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable or transmitting and receiving signals or data directly. According to an embodiment, the transceiver 28 is capable of supporting dual radio operation.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

According to one embodiment, apparatus 10 may be the UE 104 illustrated in FIGS. 1 and 2. In this embodiment, memory 14 and the computer program code stored thereon may be configured, with processor 22, to cause the apparatus 10 to detect a LTE-LAN network from broadcasted system information. The system information may be broadcast by a LTE-LAN AP, for example. Apparatus 10 may then be controlled to decide to request LTE-Hi services, and to transmit a RRC connection setup handshake to the LTE-LAN AP. The RRC connection setup handshake may include a LTE-LAN UE ID. After apparatus 10 establishes a RRC connection to the LTE-LAN AP, apparatus 10 may be controlled to send a LAN attach request RRC message to a SeNB with the LTE-LAN UE ID and information regarding the LAN radio network cell and the LTE-LAN AP.

In another embodiment, instead of sending a LAN attach request RRC message to a SeNB, apparatus 10 may be controlled to send an announcement to the SeNB through ordinary macro radio connections to indicate that it has LTE-LAN UE ID in the LTE-LAN AP. In this embodiment, apparatus 10 may then be controlled to send the attach request message through LTE-LAN radio to the LTE-LAN AP. Apparatus 10 may inform the LTE-LAN AP of the SeNB it is connected to in the RRC connection setup handshake or in the attach request message. The LTE-LAN AP may then forward the attach request message with the LTE-LAN UE ID to the appropriate SeNB based on the information received from apparatus 10. The SeNB may then perform the authentication/authorization for the LTE-LAN UE ID.

According to certain embodiments, apparatus 10 may be the SeNB 101 illustrated in FIGS. 1 and 2. In this embodiment, memory 14 and the computer program code stored thereon may be configured, with processor 22, to cause the apparatus 10 to receive from a UE or LTE-LAN AP an attach request message that may include the LTE-LAN UE ID and information regarding the LAN radio network cell and the LTE-LAN AP. Apparatus 10 may then be controlled to perform the authentication/authorization for the UE's LTE-LAN entry, and to start the context transfer procedure by sending an initial LAN context setup/attach response message with the received LTE-LAN UE ID as a UE identifier. In an embodiment, apparatus 10 may then be controlled to decide which bearers are moved to LTE-LAN access based on preconfigured policies.

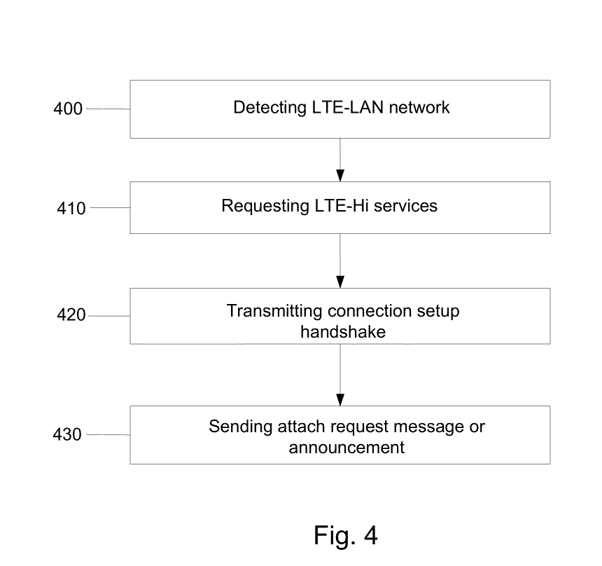

FIG. 4 illustrates a flow diagram of a method according to one embodiment. In some embodiments, the method of FIG. 4 may be performed by apparatus 10 discussed above. The method includes, at 400, detecting a LTE-LAN network from broadcasted system information. The system information may be broadcast by a LTE-LAN AP, for example. The method may then include, at 410, deciding to request LTE-Hi services, and, at 420, transmitting a RRC connection setup handshake to the LTE-LAN AP. The RRC connection setup handshake may include a LTE-LAN UE ID. The method may further include, after the RRC connection establishment to the LTE-LAN AP, at 430, sending a LAN attach request RRC message to a SeNB with the LTE-LAN UE ID and information regarding the LAN radio network cell and the LTE-LAN AP. Alternatively, instead of sending a LAN attach request RRC message to a SeNB, the method may include sending an announcement to the SeNB through ordinary macro radio connections to indicate the LTE-LAN UE ID in the LTE-LAN AP. In this case, the method may include sending the attach request message through LTE-LAN radio to the LTE-LAN AP. The method may also include informing the LTE-LAN AP of the connected SeNB in the RRC connection setup handshake or in the attach request message.

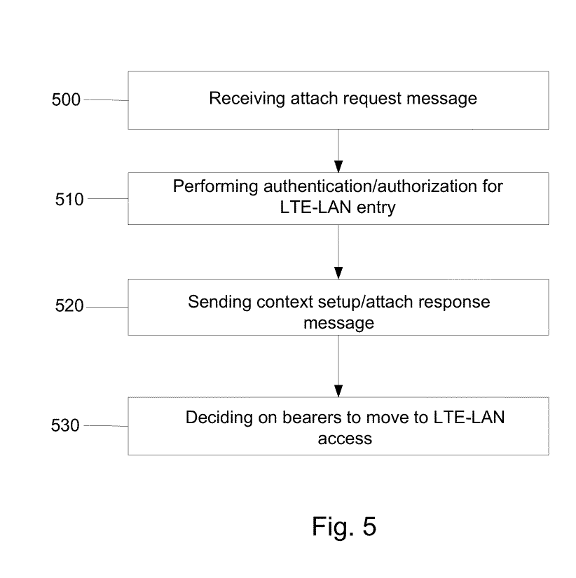

FIG. 5 illustrates a flow diagram of a method according to one embodiment. In some embodiments, the method of FIG. 5 may be performed by apparatus 10 discussed above. The method includes, at 500, receiving from a UE or LTE-LAN AP an attach request message that may include the LTE-LAN UE ID and information regarding the LAN radio network cell and the LTE-LAN AP. At 510, the method may include performing the authentication/authorization for the UE's LTE-LAN entry, and, at 520, sending an initial LAN context setup/attach response message with the received LTE-LAN UE ID as a UE identifier in order to start the context transfer procedure. The method may further include, at 530, deciding which bearers are moved to LTE-LAN access based on preconfigured policies.

In some embodiments, the functionality of the flow diagram of FIGS. 4 and 5, or that of any other method described herein, may be implemented by a software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

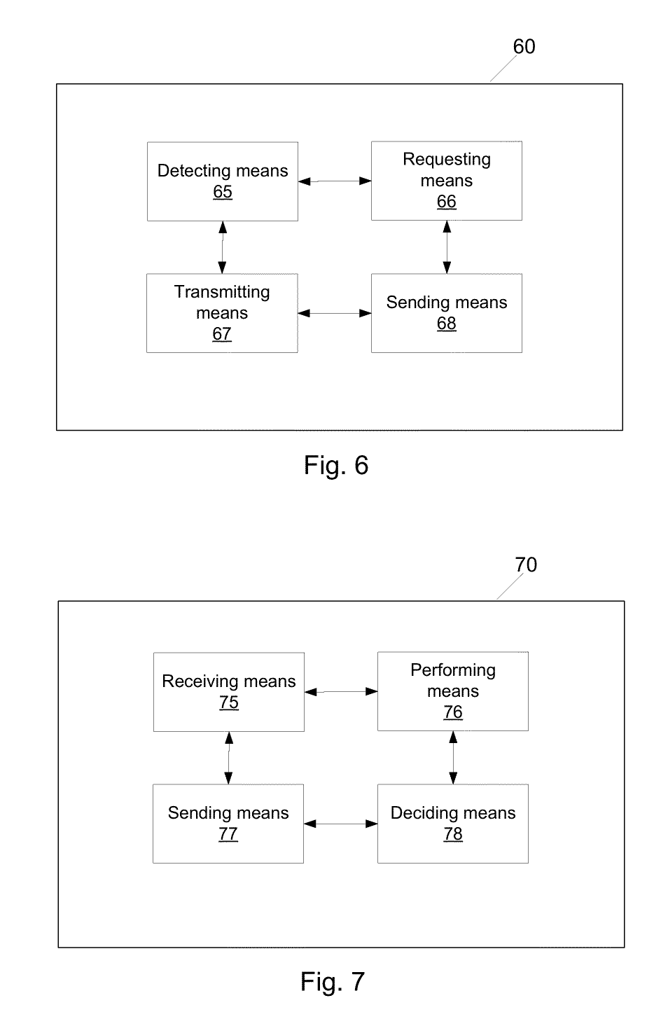

FIG. 6 illustrates an example of an apparatus 60, according to an embodiment. The apparatus includes detecting means 65 for detecting a LTE-LAN network from broadcasted system information, and requesting means 66 for requesting LTE-Hi services. The apparatus may further include transmitting means 67 for transmitting a connection setup handshake to the LTE-LAN AP. The connection setup handshake may include a LTE-LAN UE ID. The apparatus may further include, after the connection establishment to the LTE-LAN AP, sending means 68 for sending a LAN attach request message to a SeNB with the LTE-LAN UE ID or sending an announcement to the SeNB through ordinary macro radio connections to indicate the LTE-LAN UE ID in the LTE-LAN AP. The SeNB may then bind the LTE-LAN user context in the access point together with the SeNB user context for the same user equipment

FIG. 7 illustrates an example of an apparatus 70, according to another embodiment. The apparatus includes receiving means 75 for receiving, from a UE or LTE-LAN AP, an attach request message that may include the LTE-LAN UE ID and information regarding the LAN radio network cell and the LTE-LAN AP. The apparatus may further include performing means 76 for performing the authentication/authorization for the UE's LTE-LAN entry, and sending means 77 for sending an initial context setup/attach response message with the received LTE-LAN UE ID as a UE identifier in order to start the context transfer procedure. The apparatus may also include deciding means 78 for deciding which bearers are moved to LTE-LAN access based on preconfigured policies.

The computer readable media mentioned above may be at least partially embodied by a transmission line, a compact disk, digital-video disk, a magnetic disk, holographic disk or tape, flash memory, magnetoresistive memory, integrated circuits, or any other digital processing apparatus memory device.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. Further, embodiments may be combined, performed in combination or implemented together. In order to determine the metes and bounds of the invention, therefore, reference should be made to the appended claims.

We claim:

1. A method, comprising:
detecting, by user equipment, a long term evolution (LTE)-local area network (LAN) from system information broadcast by an access point;
transmitting a connection setup handshake to the access point, wherein the connection setup handshake comprises a LTE-LAN user equipment identifier; and
sending an indication of the LTE-LAN user equipment identifier to a serving node B in order to allow the serving node B to bind the LTE-LAN user context in the access point together with the serving node B user context for the user equipment.

2. The method according to claim 1, wherein the sending of the indication comprises sending a LAN attach request message to the serving node B, the LAN attach request message comprising the LTE-LAN user equipment identifier.

3. The method according to claim 1, wherein the sending of the indication comprises sending an announcement to the serving node B through macro radio connections.

4. The method according to claim 1, wherein the LTE-LAN user equipment identifier comprises at least one of system architecture evolution (SAE) temporary mobile subscriber identity (S-TMSI), an international mobile equipment identity (MEI) or medium access control (MAC) address of the LAN radio interface, an integrated circuit card identifier (ICCID), or a network access identifier (NAI).

5. The method according to claim 1, wherein the connection setup handshake comprises a radio resource control connection setup handshake.

6. The method according to claim 1, wherein the access point is configured to store the LTE-LAN user equipment identifier as part of a user equipment context.

7. An apparatus, comprising:
at least one processor; and
at least one memory including computer program code,
wherein the at least one memory and the computer program code, with the at least one processor, are configured to cause the apparatus at least to
detect a long term evolution (LTE)-local area network (LAN) from system information broadcast by an access point;
transmit a connection setup handshake to the access point, wherein the connection setup handshake comprises a LTE-LAN user equipment identifier; and
send an indication of the LTE-LAN user equipment identifier to a serving node B in order to allow the serving node B to bind the LTE-LAN user context in the access point together with the serving node B user context for the user equipment.

8. The apparatus according to claim 7, wherein the apparatus comprises a dual radio capable user equipment.

9. The apparatus according to claim 7, wherein the at least one memory and the computer program code, with the at least one processor, are further configured to cause the apparatus at least to send a LAN attach request message to the serving node B, the LAN attach request message comprising the LTE-LAN user equipment identifier.

10. The apparatus according to claim 7, wherein the at least one memory and the computer program code, with the at least one processor, are further configured to cause the apparatus at least to send an announcement to the serving node B through macro radio connections.

11. The apparatus according to claim 7, wherein the LTE-LAN user equipment identifier comprises at least one of system architecture evolution (SAE) temporary mobile subscriber identity (S-TMSI), an international mobile equipment identity (MEI) or medium access control (MAC) address of the LAN radio interface, an integrated circuit card identifier (ICCID), or a network access identifier (NAI).

12. The apparatus according to claim 7, wherein the connection setup handshake comprises a radio resource control connection setup handshake.

13. A computer program embodied on a computer readable medium, the computer program configured to control a processor to perform a process, the process comprising:
detecting, by user equipment, a long term evolution (LTE)-local area network (LAN) from system information broadcast by an access point;
transmitting a connection setup handshake to the access point, wherein the connection setup handshake comprises a LTE-LAN user equipment identifier; and
sending an indication of the LTE-LAN user equipment identifier to a serving node B in order to allow the serving node B to bind the LTE-LAN user context in the access point together with the serving node B user context for the user equipment.

14. A method, comprising:
receiving an attach request message from a user equipment or a long term evolution (LTE)-local area network (LAN) access point, the attach request message comprising a LTE-LAN user equipment identifier;
performing authentication and authorization for entry of the user equipment to the LTE-LAN; and
sending an initial context setup/attach response message with the received LTE-LAN user equipment identifier in order to start a context transfer procedure.

15. The method according to claim 14, wherein the attach request message further comprises information about the LTE-LAN access point and the LAN radio network cell.

16. The method according to claim 14, further comprising deciding which bearers are moved to LTE-LAN access based on pre-configured policies.

17. An apparatus, comprising:
at least one processor; and
at least one memory including computer program code,
wherein the at least one memory and the computer program code, with the at least one processor, are configured to cause the apparatus at least to
receive an attach request message from a user equipment or a long term evolution (LTE)-local area network (LAN) access point, the attach request message comprising a LTE-LAN user equipment identifier;
perform authentication and authorization for entry of the user equipment to the LTE-LAN; and
send an initial context setup/attach response message with the received LTE-LAN user equipment identifier in order to start a context transfer procedure.

18. The apparatus according to claim 17, wherein the apparatus comprises a node B.

19. The apparatus according to claim 17, wherein the attach request message further comprises information about the LTE-LAN access point and the LAN radio network cell.

20. The apparatus according to claim 17, wherein the at least one memory and the computer program code, with the at least one processor, are further configured to cause the apparatus at least to decide which bearers are moved to LTE-LAN access based on pre-configured policies.

21. A computer program embodied on a computer readable medium, the computer program configured to control a processor to perform a process, the process comprising:
receiving an attach request message from a user equipment or a long term evolution (LTE)-local area network (LAN) access point, the attach request message comprising a LTE-LAN user equipment identifier;
performing authentication and authorization for entry of the user equipment to the LTE-LAN; and
sending an initial context setup/attach response message with the received LTE-LAN user equipment identifier in order to start a context transfer procedure.
